(19) United States
(12) Patent Application Publication
(10) Pub. No.: US 2013/0002956 A1
(43) Pub. Date: Jan. 3, 2013

(54) PORTABLE COMMUNICATION DEVICE AND METHOD FOR REMOTE CONTROL OF MULTIMEDIA DEVICE

(75) Inventor: MING-MOU CHEN, Tu-Cheng (TW)

(73) Assignee: HON HAI PRECISION INDUSTRY CO., LTD., Tu-Cheng (TW)

(21) Appl. No.: 13/537,070

(22) Filed: Jun. 29, 2012

(30) Foreign Application Priority Data
Jun. 30, 2011 (TW) 100122997

(51) Int. Cl. H04N 5/44; H04N 5/445

(52) U.S. Cl. 348/563; 348/734; 348/E05.096; 348/E05.105

(57) ABSTRACT

A portable communication device for remote control of a multimedia device includes a motion sensor, a command generation module and a wireless communication interface. The motion sensor senses various motions of the portable communication device and generates signals corresponding to the sensed motions. The command generation module translates one or more of the signals into remote control commands for remote control of the multimedia device. The wireless communication interface transmits the remote control commands to the multimedia device. A method for remote control of the multimedia device using the portable communication device is also provided.

### BACKGROUND

1. Technical Field

Embodiments of the present disclosure relate to a portable communication device and a method for remote control of a multimedia device using the portable communication device.

2. Description of Related Art

Nowadays multimedia devices support more functions than previously, such as electronic program guide (EPG) functions and Internet access functions. Correspondingly, remote control of all the functions is more complicated. Complicated functions require various graphical user interfaces, and cannot be efficiently controlled by a traditional infrared-ray button-type remote control. The touch-sensitive means of input provided by a portable communication device can be an alternative to traditional remote controls. However, a user still has to look at and operate a touch screen or a soft keyboard of the portable communication device, in order to touch a predetermined area for remotely controlling the multimedia device.

Therefore, a portable communication device capable of overcoming the aforementioned deficiencies and inadequacies is needed.

### BRIEF DESCRIPTION OF THE DRAWINGS

FIG. 1 is a block diagram of one embodiment of a portable communication device, in accordance with the present disclosure.

FIG. 2 is a flowchart of one embodiment of a method of remote control of a multimedia device, in accordance with the present disclosure.

FIG. 3 is a flowchart of one embodiment of a method of remotely controlling shifting of a focus region on a menu displayed by the multimedia device, in accordance with the present disclosure.

FIG. 4 is a flowchart of another embodiment of a method of remote control of the multimedia device, in accordance with the present disclosure.

FIG. 5 is a flowchart of one embodiment of a method of remotely controlling setting a function mode of the multimedia device, in accordance with the present disclosure.

### DETAILED DESCRIPTION

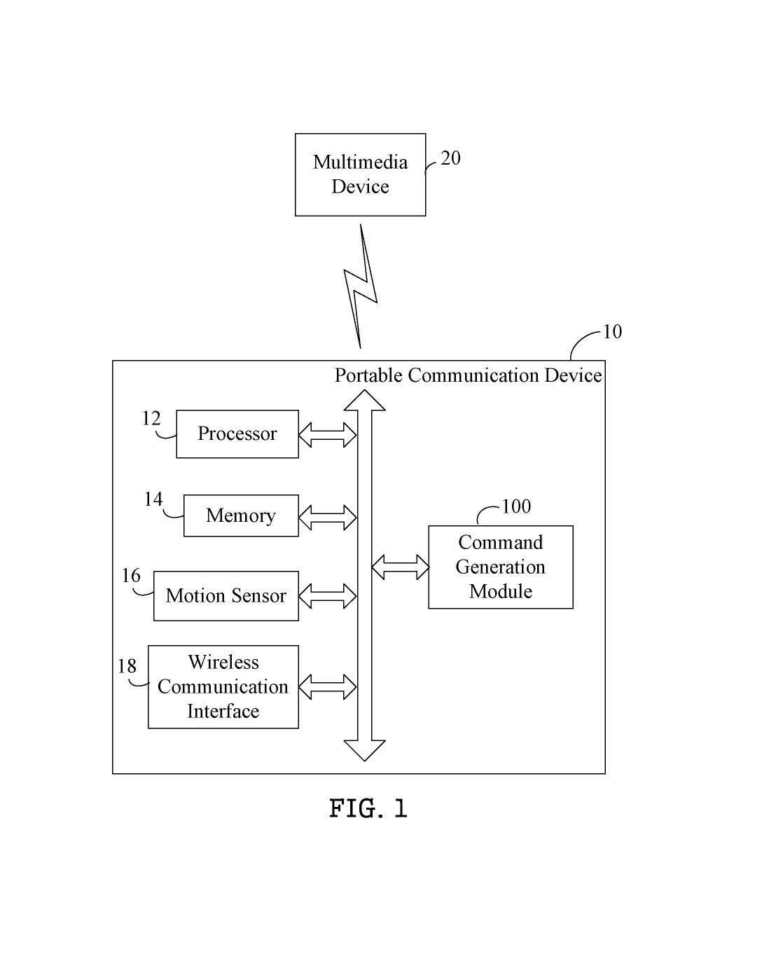

FIG. 1 is a block diagram of one embodiment of a portable communication device 10. The portable communication device 10 may be a mobile phone, a mobile radio terminal, a smart phone, a personal digital assistant (PDA), or another kind of mobile device. The portable communication device 10 includes a processor 12, a memory 14, a motion sensor 16, a wireless communication interface 18, and a command generation module 100.

In general, the word “module” as used herein, refers to logic embodied in hardware or firmware, or a collection of software instructions, written in a program language. In one embodiment, the program language may be Java or C language. The command generation module 100 described herein may be implemented as either a software and/or hardware module(s) and may be stored in the memory 14. One or more software instructions of the command generation module 100 may be executed by the processor 12. The processor 12 can include a general-purpose processor, a specialized processor, a microprocessor, or similar component that executes software instructions. In one embodiment, the processor 12 operates under control of logic embodied in firmware stored in the memory 14. The memory 14 includes volatile and nonvolatile memory, and removable and non-removable media implemented in any method or technology for storage of information such as computer-readable instructions, data structures, program modules or other data.

The motion sensor 16 includes at least one of a gyro sensor, an acceleration sensor and a geomagnetic sensor. By using one of the sensors or by combining two or more sensors with each other, all motions of the portable communication device 10 can be sensed. The wireless communication interface 18 includes one or more other local wireless interfaces, such as an infrared transceiver and/or a radio frequency (RF) adapter, e.g., a Bluetooth™ adapter, a wireless local area network (WLAN) adapter, an Ultra-Wideband (UWB) adapter and the like, for establishing communication with a multimedia device 20. The multimedia device 20 may include a television and/or a set-top box (STB). Also, the wireless communication interface 18 may be representative of an interface for establishing communication within a cellular network or other wireless wide-area network (WWAN). The command generation module 100 can translate motion of the portable communication device 10 sensed by the motion sensor 16 into various remote control commands to control the multimedia device 20. The processor 12 controls the overall functions of the portable communication device 10. The processor 12 can transmit, to the multimedia device 20, the remote control commands generated by the command generation module 100, through the wireless communication interface 18.

The motion sensor 16 serves to sense various motions of the portable communication device 10, with such motions functioning as remote user input of data or motion commands. The multimedia device 20 can display a graphical user interface, and respond to remote control commands of the portable communication device 10 output by the portable communication device 10 in response to the motion commands of the user. Typically, the multimedia device 20 responds to the remote control commands by adjusting or changing the graphical user interface according to each remote control command. In this regard, the command generation module 100 may be configured or otherwise programmed to recognize a plurality of predetermined motions of the portable communication device 10, and to translate each of the plurality of predetermined motions into one or more remote control commands that are wirelessly transmitted to the multimedia device 20. Examples of types of recognizable motions are described below.

For example, the command generation module 100 can be configured to recognize motions of the portable communication device 10 in upward, downward, leftward and rightward directions. In one embodiment, the user can move the portable communication device 10 in a specific direction, and then return the portable communication device 10 to an original position. The command generation module 100 translates such movement into a command to shift a focus region on a menu displayed by the multimedia device 20. For example, the multimedia device 20 displays a starting menu, and then the user moves the portable communication device 10 in a certain way (e.g. down) and then brings the portable communication device 10 substantially back up to its original position. The command generation module 100 translates such motion of the portable communication device 10 into a remote control command to shift the focus region on the menu displayed by the multimedia device 20; for example, to shift the focus region on the menu down one line.

In one embodiment, the focus region on the menu highlights a single menu item of the menu. For example, the highlighted menu item can be a channel currently viewed by the user, a volume level of audio signals currently output by the multimedia device 20, a URL (Uniform Resource Locator, i.e. webpage) currently accessed by the user, or any other menu item of a corresponding menu. A focus region shifting on the menu changes a highlighted, and therefore potentially selectable, menu item from one menu item to another one. For example, the focus region shifting on a volume menu can include shifting of item highlighting among a volume-up menu item, a volume-down menu item, and a volume-mute menu item. The focus region shifting from a currently viewed channel permits a channel change. In general, the focus region shifting among menu items triggers highlighting of the menu item which is immediately adjacent to the currently highlighted menu item. In another embodiment, the focus region shifting may also act as an “enter” command That is, when a new menu item is highlighted, it is also automatically selected and activated.

In one embodiment, the motion sensor 16 can sense that the portable communication device 10 is moved from a first position to a second position in a first direction, that the portable communication device 10 is then stationary for a period of time which is shorter than a predetermined time period, and that the portable communication device 10 is then moved from the second position back to substantially the first position in an opposite second direction. The command generation module 100 receives signals indicating motion from the motion sensor 16, recognizes the movement of the portable communication device 10 toward the first direction, and then translates the signals into a remote control command to shift the focus region in a third direction on the menu. In one embodiment, the first direction, the second direction and the third direction can be chosen in advance from an upward, a downward, a leftward and a rightward direction, and preset accordingly. For example, the first direction is chosen to be rightward, the second direction is chosen to be leftward, and the third direction is chosen to be rightward.

For example, if navigation of the menu layout requires movement in four directions, the command generation module 100 can translate upward and downward movements of the portable communication device 10 into remote control commands to vertically shift the focus region on the menu, and can translate leftward and rightward movements of the portable communication device 10 into remote control commands to shift the focus region on the menu horizontally. In relation to a channel currently playing on the multimedia device 20, the command generation module 100 can translate vertical movements of the portable communication device 10 into remote control commands to change the channel, and can translate horizontal movements of the portable communication device 10 into remote control commands to adjust the volume up or down.

In one embodiment, the first direction and the second direction need not necessarily be exactly opposite directions. That is, the first direction and the second direction may be exactly opposite directions, or may be approximately opposite directions. In such case, the user of the portable communication device 10 can still achieve a desired shifting of the focus region even when the user does not move the portable communication device 10 in exactly the right direction he/she intends to move the portable communication device 10. For example, each of the first direction and the second direction can be chosen in advance from a group consisting of a vertically upward, vertically downward, horizontally to the left, horizontally to the right, diagonally up to the left, diagonally down to the left, diagonally up to the right, and diagonally down to the right direction. The third direction corresponds to a layout of the menu displayed by the multimedia device 20, and is one of a vertically upward, vertically downward, horizontally to the left, and horizontally to the right direction.

For example, if a vertical menu layout only needs upward or downward shifting of the focus region, the movements of the portable communication device 10 can be mapped by the command generation module 100 to corresponding shifting of the focus region as follows. Movements vertically upward, diagonally up to the left, and diagonally up to the right are translated by the command generation module 100 into a remote control command to shift the focus region upward. Movements vertically downward, diagonally down to the left, and diagonally down to the right are translated by the command generation module 100 into a remote control command to shift the focus region downward.

In one embodiment, the motion sensor 16 may sense that the portable communication device 10 is moved from the first position to the second position, that the portable communication device 10 is stationary at the second position for a period of time which is longer than the predetermined time period, and that the portable communication device 10 is then finally moved back from the second position to substantially the first position. In this case, the command generation module 100 receives signals indicating the aforementioned motions from the motion sensor 16, and recognizes the movements of the portable communication device 10 as well as recognizing that the portable communication device 10 is held stationary for the period of time which is longer than the predetermined time period. The command generation module 100 translates the signals of motion from the first position to the second position followed by signals of a stationary status into a remote control command to continuously shift the focus region on the menu in a cyclic manner, and translates the subsequent signals of motion from the second position back to substantially the first position into a remote control command to stop shifting the focus region.

For example, the aforementioned intermediate stationary state of the portable communication device 10 can be translated into a continuously-increasing volume-up remote control command, a continuously-increasing channel up remote control command, or another kind of continuously-increasing focus region shifting remote control command. The continuously progressing or continuously cyclic shifting subsists until the user moves the portable communication device 10 in the second direction back to substantially the first position.

In order to improve user experience, the motion sensor 16 further senses the speed of motion of the portable communication device 10, and the command generation module 100 translates the motion speed of the portable communication device 10 into a focus region shifting speed on the menu displayed by the multimedia device 20. Thus, the user can move the portable communication device 10 faster in order to speed up menu navigation.

In one embodiment, the motion sensor 16 can sense that the portable communication device 10 is being rotated in either of opposite directions. The command generation module 100 receives signals indicating the aforementioned motions from the motion sensor 16, recognizes the user is rotating the portable communication device 10, and translates the signals into a remote control command to activate the highlighted menu item in the focus region or go back one hierarchical level among menu levels of the multimedia device 20, respectively. For example, if the motion sensor 16 senses that the portable communication device 10 is being rotated in a first direction, then the command generation module 100 commands the activation of the highlighted menu item in the focus region. If the motion sensor 16 senses that the portable communication device 10 is being rotated in an opposite second direction, then the command generation module 100 commands the highlighting to go back one hierarchical level among menu levels of the multimedia device 20. The first direction can be a clockwise or a counterclockwise direction, and the second direction can be a counterclockwise or a clockwise direction correspondingly.

In one embodiment, a stationary orientation of the portable communication device 10 for a predetermined period of time can remotely control a function mode of the multimedia device 20. The orientation of the portable communication device 10 can be horizontal, in either a face-up position in which an input surface of the portable communication device 10 is pointing up, or a face-down position in which the input surface of the portable communication device 10 is pointing down. The orientation of the portable communication device 10 can also be vertical. Thus for example, function mapping associated with a plurality of predetermined function modes can be defined by the command generation module 100. Each one of the predetermined function modes has a menu. The predetermined function modes can include a menu navigation mode, a television mode, and a webpage browsing mode. In one embodiment, the motion sensor 16 senses the orientation of the portable communication device 10, and the command generation module 100 generates a corresponding remote control command to set the current function mode of the multimedia device 20 according to the function mapping. The command generation module 100 further translates signals subsequently received into remote control commands corresponding to the current function mode of the multimedia device 20.

For example, when the user holds the portable communication device 10 in an orientation which corresponds to the menu navigation mode, the command generation module 100 generates a remote control command to set the menu navigation mode as the current function mode of the multimedia device 20. After that, movements of the portable communication device 10 are translated by the command generation mode 100 into various remote control commands applying to the menu navigation mode. If the user holds the portable communication device 10 in an orientation corresponding to the television mode, the command generation module 100 generates a remote control command to set the television mode as the current function mode of the multimedia device 20. After that, movements of the portable communication device 10 are translated by the command generation mode 100 into various remote control commands which apply to volume changes and channel changes. If the user holds the portable communication device 10 in an orientation corresponding to the webpage browsing mode, the command generation module 100 generates a remote control command to set the webpage browsing mode as the current function mode of the multimedia device 20. After that, movements of the portable communication device 10 are translated by the command generation mode 100 into various remote control commands that activate a highlighted URL, access a previous webpage, or access a next webpage.

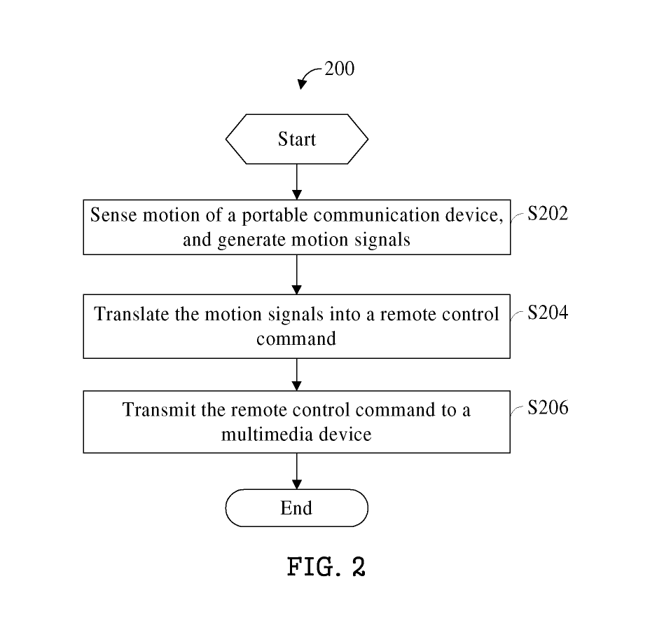

FIG. 2 is a flowchart 200 of one embodiment of a method of remote control of the multimedia device 20. In step S202, the motion sensor 16 senses a motion of the portable communication device 10, and generates and outputs corresponding motion signals. In step S204, the command generation module 100 receives the motion signals and translates the motion signals into a remote control command. In step S206, the processor 12 transmits the remote control command to the multimedia device 20 through the wireless communication interface 18.

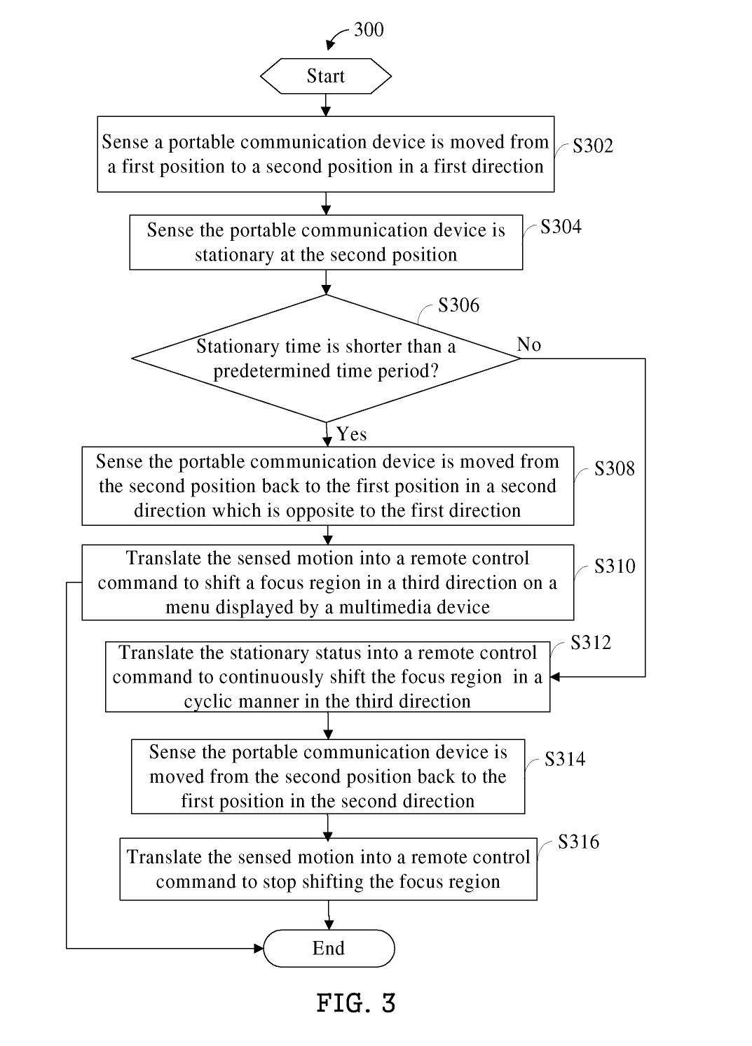

FIG. 3 is a flowchart 300 of one embodiment of a method of remotely controlling shifting of the focus region on a menu displayed by the multimedia device 20. In step S302, the motion sensor 16 senses the portable communication device 10 being moved from a first position to a second position in a first direction. In step S304, the motion sensor 16 further senses that the portable communication device 10 is held stationary at the second position. In step S306, the command generation module 100 receives signals indicating the aforementioned motion and stationary status from the motion sensor 16, and determines whether the stationary time is shorter than the predetermined time period. If the stationary time is shorter than the predetermined time period, the procedure goes to step S308. If the stationary time is longer than the predetermined time period, the procedure goes to step S312.

In step S308, the motion sensor 16 further senses that the portable communication device 10 is moved from the second position back to substantially the first position in a second direction which is opposite to the first direction. In step S310, the command generation module 100 translates the motion of the portable communication device 10 into a remote control command to shift the focus region in a third direction on the menu displayed by the multimedia device 20.

In step S312, the command generation module 100 translates the aforementioned motion and subsequent stationary status into a remote control command to continuously shift the focus region in a cyclic manner in the third direction on the menu displayed by the multimedia device 20. In step S314, the motion sensor 16 senses that the portable communication device 10 is moved from the second position back to substantially the first position in the second direction which is opposite to the first direction. In step S316, the command generation module 100 translates the motion of the portable communication device 10 into a remote control command to stop shifting the focus region.

In addition, in order to improve user experience, in step S302, the motion sensor 16 can further sense the speed of motion of the portable communication device 10. Accordingly, in step S312, the command generation module 100 translates the motion speed of the portable communication device 10 into a focus region shifting speed on the menu displayed by the multimedia device 20. Thus, the user can speed up the navigation of the menu by moving the portable communication device 10 faster.

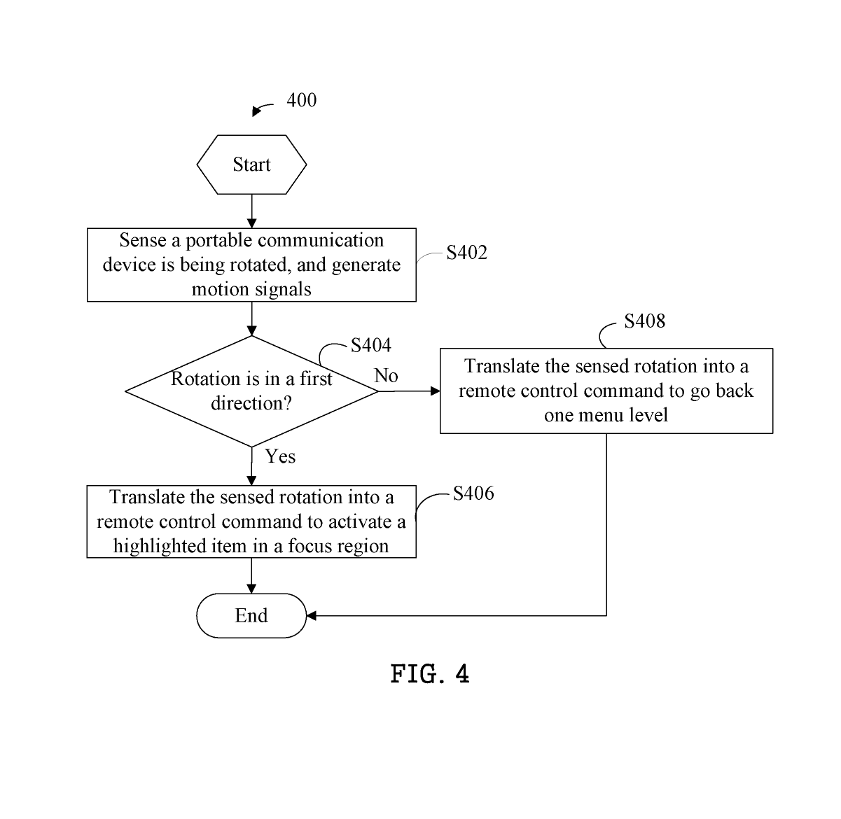

FIG. 4 is a flowchart 400 of another embodiment of a method of remote control of the multimedia device 20. In step S402, the motion sensor senses that the portable communication device 10 is being rotated, and generates and outputs corresponding motion signals. In step S404, the command generation module 100 receives the motion signals, and determines whether the portable communication device 10 is being rotated in a first direction. If the portable communication device 10 is being rotated in the first direction, the procedure goes to step S406. If the portable communication device 10 is being rotated in a second direction opposite to the first direction, the procedure goes to step S408. The first direction can be a clockwise direction or a counterclockwise direction, and correspondingly the second direction can be a counterclockwise direction or a clockwise direction.

In step S406, the command generation module 100 translates the motion signals into a remote control command to activate a highlighted item in the focus region.

In step S408, the command generation module 100 translates the motion signals into a remote control command to go back one hierarchical level among menu levels of the multimedia device 20.

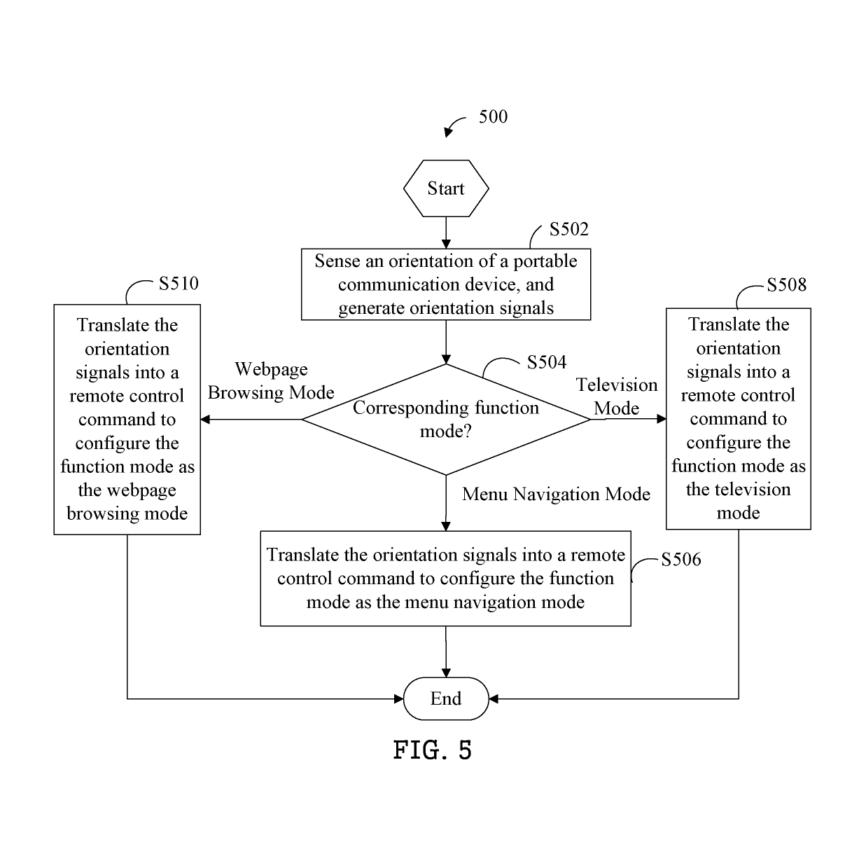

FIG. 5 is a flowchart 500 of one embodiment of a method of remotely controlling setting a function mode of the multimedia device 20. In this method, the orientation of the portable communication device 10 can remotely control the function mode of the multimedia device 20. In step S502, the motion sensor 16 senses an orientation of the portable communication device 10, and generates and outputs corresponding orientation signals. The orientation of the portable communication device 10 can be horizontally face-up, horizontally face-down, or vertical. In step S504, the command generation module 100 receives the signals indicating the orientation sensed by the motion sensor 16, and determines a corresponding function mode of the multimedia device 20. If the corresponding function mode is a menu navigation mode, in step S506, the command generation module 100 translates the orientation signals into a remote control command to set the menu navigation mode as the current function mode of the multimedia device 20, and further translates subsequently received signals into remote control commands appropriate to the menu navigation mode. If the corresponding function mode is a television mode, in step S508, the command generation module 100 translates the orientation signals into a remote control command to set the television mode as the current function mode of the multimedia device 20, and further translates subsequently received signals into remote control commands which correspond to the television mode. If the corresponding function mode is a webpage browsing mode, in step S510, the command generation module 100 translates the orientation signals into a remote control command to set the webpage browsing mode as the current function mode of the multimedia device 20, and further translates subsequently received signals into remote control commands applicable to the webpage browsing mode.

In summary, the above-described remote control methods translate motion of the portable communication device 10 into various remote control commands for remote control of the multimedia device 20 in a simple way which can very soon become intuitive for a user.

The foregoing disclosure of various embodiments has been presented for purposes of illustration and description. It is not intended to be exhaustive or to limit the disclosure to the precise forms disclosed. Many variations and modifications of the embodiments described herein will be apparent to one of ordinary skill in the art in light of the above disclosure. The scope of the disclosure is not limited to the claims appended hereto and their equivalents.

What is claimed is:

1. A portable communication device for remote control of a multimedia device, the portable communication device comprising:
a motion sensor sensing various motions of the portable communication device as motion commands performed by a user and generating signals corresponding to the sensed motions of the portable communication device;
a command generation module translating the signals into one or more remote control commands for remote control of the multimedia device; and
a wireless communication interface transmitting the remote control commands to the multimedia device.

2. The portable communication device of claim 1, wherein the motion sensor senses that in one motion the portable communication device is moved from a first position to a second position in a first direction, and that the portable communication device is stationary at the second position for a period of time which is shorter than a predetermined time period, and that the portable communication device is then moved from the second position back to substantially the first position in an opposite second direction; and the command generation module translates the signals indicating the motion into a remote control command to shift a focus region on a menu item on a menu displayed by the multimedia device in a third direction to an immediately adjacent menu item.

3. The portable communication device of claim 1, wherein the motion sensor senses that in one motion the portable communication device is moved from a first position to a second position in a first direction, and that the portable communication device is stationary at the second position for a period of time which is longer than a predetermined time period; and the command generation module translates the signals indicating the motion into a remote control command to continuously shift a focus region on a menu item on a menu displayed by the multimedia device in a third direction in a cyclic manner.

4. The portable communication device of claim 3, wherein the motion sensor further senses that in the motion the portable communication device is then moved from the second position back to substantially the first position in an opposite second direction; and the command generation module further translates the signals indicating the motion into a further remote control command to stop shifting the focus region.

5. The portable communication device of claim 4, wherein the motion sensor further senses a speed of the motion of the portable communication device when the portable communication device is moved from the first position to the second position; and the command generation module translates the motion speed of the portable communication device into a speed of continuously shifting the focus region, the speed of continuously shifting the focus region forming part of the remote control command to continuously shift the focus region.

6. The portable communication device of claim 2, wherein the first direction is selected from the group consisting of an upward direction, a downward direction, a leftward direction and a rightward direction.

7. The portable communication device of claim 6, wherein the second direction is correspondingly selected from the group consisting of a downward direction, an upward direction, a rightward direction and a leftward direction.

8. The portable communication device of claim 4, wherein the first direction is selected from the group consisting of an upward direction, a downward direction, a leftward direction and a rightward direction.

9. The portable communication device of claim 8, wherein the second direction is correspondingly selected from the group consisting of a downward direction, an upward direction, a rightward direction and a leftward direction.

10. The portable communication device of claim 1, wherein the motion sensor senses that in one motion the portable communication device is rotated in a first direction; and the command generation module translates the signals indicating the motion into a remote control command to activate a highlighted menu item in a focus region on a menu displayed by the multimedia device.

11. The portable communication device of claim 10, wherein the motion sensor further senses that in another motion the portable communication device is rotated in a second direction opposite to the first direction; and the command generation module translates the signals indicating the other motion into a remote control command to go back from a menu displayed by the multimedia device one hierarchical level among menu levels of the multimedia device.

12. The portable communication device of claim 10, wherein the first direction is one of a clockwise direction and a counterclockwise direction.

13. The portable communication device of claim 11, wherein the second direction is correspondingly one of a counterclockwise direction and a clockwise direction.

14. The portable communication device of claim 1, wherein the motion sensor further senses various orientations of the portable communication device as orientation commands performed by a user and generates signals corresponding to the sensed orientations of the portable communication device; and the command generation module translates the signals indicating the sensed orientations of the portable communication device into various remote control commands to set various function modes of the multimedia device.

15. The portable communication device of claim 14, wherein the function modes comprise a menu navigation mode, a television mode and a webpage browsing mode.

16. A control method executable by a portable communication device operable to remotely control functioning of a multimedia device, wherein the portable communication device comprises a motion sensor and a wireless communication interface, the method comprising:
sensing a motion of the portable communication device as a motion command performed by a user, and generating one or more signals corresponding to the sensed motion, by the motion sensor;
translating the signals into one or more remote control commands for remote control of the multimedia device; and
transmitting the remote control commands to the multimedia device through the wireless communication interface.

17. The method of claim 16, further comprising:
sensing that in the motion the portable communication device is moved from a first position to a second position in a first direction;
sensing that in the motion the portable communication device is stationary at the second position for a period of time which is shorter than a predetermined time period;
sensing that in the motion the portable communication device is moved from the second position back to substantially the first position in an opposite second direction; and
translating the signals indicating the motion into a remote control command to shift a focus region on a menu item on a menu displayed by the multimedia device in a third direction to an immediately adjacent menu item.

18. The method of claim 16, further comprising:
sensing that in the motion the portable communication device is moved from a first position to a second position in a first direction;
further sensing that in the motion the portable communication device is stationary at the second position for a period of time which is longer than a predetermined time period;
translating the signals indicating the motion into a remote control command to continuously shift a focus region on a menu item on a menu displayed by the multimedia device in a third direction in a cyclic manner;
further sensing that in the motion the portable communication device is then moved from the second position back to substantially the first position in an opposite second direction; and
further translating the signals indicating the motion into a further remote control command to stop shifting the focus region.

19. The method of claim 16, further comprising:
sensing that in the motion the portable communication device is rotated in a first direction;
translating the signals indicating the motion into a remote control command to activate a highlighted menu item in a focus region on a menu displayed by the multimedia device;
further sensing that in another motion the portable communication device is rotated in a second direction opposite to the first direction; and
further translating the signals indicating the other motion into another remote control command to go back one hierarchical level among menu levels of the multimedia device.

20. The method of claim 16, further comprising:
sensing an orientation of the portable communication device as an orientation command performed by a user, and generating one or more signals corresponding to the sensed orientation; and
translating the signals into a remote control command to select a function mode of the multimedia device.
